(19) United States
(12) Patent Application Publication
(10) Pub. No.: US 2025/0145507 A1
(43) Pub. Date: May 8, 2025

(54) METHOD FOR TREATING REFRACTORY ORGANIC POLLUTANTS IN WASTEWATER

(71) Applicant: Nanjing University, Nanjing (CN)

(72) Inventors: Weiming ZHANG, Nanjing (CN); Xiaoyang LI, Nanjing (CN); Han ZHANG, Nanjing (CN); Zhichao YANG, Nanjing (CN); Chao SHAN, Nanjing (CN); Ming HUA, Nanjing (CN); Lu LYU, Nanjing (CN); Bingcai PAN, Nanjing (CN)

(21) Appl. No.: 18/593,840

(22) Filed: Mar. 1, 2024

(30) Foreign Application Priority Data
Nov. 3, 2023 (CN) 202311462151.4

(51) Int. Cl. C02F 1/72; B01J 21/04; B01J 35/61; B01J 37/03; B01J 37/06; B01J 37/08; C02F 1/66; C02F 1/76; C02F 101/34; C02F 101/38

(52) U.S. Cl. CPC C02F 1/725; B01J 21/04; B01J 35/615; B01J 37/031; B01J 37/06; B01J 37/08; C02F 1/66; C02F 1/722; C02F 1/76; C02F 2101/345; C02F 2101/38; C02F 2101/40; C02F 2305/023

(57) ABSTRACT

A method for treating refractory organic pollutants in wastewater including: synthesizing an aluminum-based metal oxide with a high specific surface area and surface hydroxyl content; mixing organic pollutants, an oxidant, and chloride ions to yield a reaction solution; adjusting an initial pH value of the reaction solution; and adding the aluminum-based metal oxide to the reaction solution.

### CROSS-REFERENCE TO RELATED APPLICATIONS

Pursuant to 35 U.S.C. § 119 and the Paris Convention Treaty, this application claims foreign priority to Chinese Patent Application No. 202311462151.4 filed Nov. 3, 2023, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure relates to the field of water treatment technology, and more particularly to a method for treating refractory organic pollutants in wastewater.

A large number of inorganic anions often coexist in wastewater, among which chloride ion is one of the common. Chloride ion can quench active species and thus affect the catalytic efficiency of advanced oxidation technology. Thus, the oxidation degradation of pollutants in chlorine-containing wastewater has always been a challenge in the field of water treatment.

Much attention has been paid to variable valence metal-based heterogeneous catalysts such as iron/copper/cobalt, which utilizes the redox cycle process of metal catalytic sites to achieve the activation of oxidants. However, during the process of valence change, metals are prone to precipitate and cause secondary pollution, and the induced free radicals are easily influenced by coexisting ions and organic matter.

### SUMMARY

The disclosure provides a method for treating refractory organic pollutants in wastewater. The method comprises: synthesizing an aluminum-based metal oxide with a high specific surface area and surface hydroxyl content; mixing organic pollutants, an oxidant, and chloride ions to yield a reaction solution; adjusting an initial pH value of the reaction solution; and adding the aluminum-based metal oxide to the reaction solution.

In a class of this embodiment, the aluminum-based metal oxide comprises activated alumina.

In a class of this embodiment, the preparation of activated alumina comprises coprecipitation method, sol-gel method, gas phase method, etc.

In a class of this embodiment, a specific surface area of the activated alumina ranges from 100 to 300 m²/g; the surface hydroxyl content accounts for 30% to 60% of a total oxygen content of activated alumina.

In a class of this embodiment, an addition amount of the activated alumina ranges from 0.50 to 1.50 g/L.

In a class of this embodiment, the initial pH value of the reaction solution is between 3.0 and 7.0, particularly, 3.0.

In a class of this embodiment, the oxidant is peroxymonosulfate, persulfate, peroxyacetic acid, hydrogen peroxide, or a combination thereof.

In a class of this embodiment, a molar ratio of the organic pollutants to the oxidant in the reaction solution is between 1:10 and 1:1, particularly, 1:10.

In a class of this embodiment, the chloride ions have a concentration great than or equal to 1.0 mM, particularly, between 1.0 mM (mmol/L) and 500 mM, and more particularly, 250 mM.

In a class of this embodiment, the organic pollutants comprise phenols, amino groups, sulfonamides, sulfoxides, or a combination thereof.

In a class of this embodiment, the organic pollutants comprise o-methylphenol, carbamazepine, sulfamethoxazole, methylphenyl sulfoxide, or a combination thereof.

In another aspect, the disclosure further provides use of the method for water treatment, specifically, the method utilizes endogenous chloride ions in the water body for the deep treatment of chlorine-containing wastewater with a chloride ion concentration in the range of 1.0-500.0 mM.

The following advantages are associated with the method for treating refractory organic pollutants in wastewater of the disclosure:

Aluminum based metal oxides, especially activated alumina as heterogeneous Fenton catalysts, coordinate through inner spheres with oxidant anions to form surface complexes, and the surface complexes react with coexisting chloride ions to generate active species such as free chlorine, singlet oxygen, hydroxyl radicals, sulfate radicals, etc.

The reaction process does not involve the redox cycle of metal catalytic sites, and the metal ions are stable and not easy to precipitate; aluminum ions are also less biotoxic compared to heavy metal ions such as cobalt and copper.

The main active species involved in the method are free chlorine, single-linear oxygen, etc., which are highly selective for electron-rich pollutants, so that the method features more controllable catalytic oxidation scenarios and high oxidant utilization efficiency.

In addition to the degradation of organic pollutants, the method also has strong inactivation activity on various pathogens in the tail water, preventing bacterial regeneration.

### BRIEF DESCRIPTION OF THE DRAWINGS

FIG. 1 shows a process chart of a method for treating refractory organic pollutants in wastewater according to one embodiment of the disclosure;

FIG. 2 shows a schematic diagram of an oxidation effect on carbamazepine under different oxidant systems in Example 1;

FIG. 3 shows a schematic diagram of the oxidation effect of different systems on carbamazepine in Example 2;

FIG. 4 shows a schematic diagram of an oxidation effect of different crystalline alumina on carbamazepine in Example 3;

FIG. 5 shows a schematic diagram of an oxidation effect of different heterogeneous catalysts on carbamazepine in chlorine containing wastewater in Example 4;

FIG. 6 shows a schematic diagram of an oxidation effect of different chloride ion concentrations on carbamazepine in Example 5;

FIG. 7 shows a schematic diagram of an oxidation effect of carbamazepine in chlorine containing wastewater under different pH conditions in Example 6;

FIG. 8 shows a schematic diagram of an oxidation effect under different molar ratios of peroxymonosulfate to carbamazepine in Example 7;

FIG. 9 shows a schematic diagram of an oxidation effect of activated alumina-peroxymonosulfate-chloride ions on different organic pollutants in chlorine containing wastewater in Example 8;

FIG. 10 shows a schematic diagram of an oxidation effect of different catalyst dosages on carbamazepine in chlorine containing wastewater in Example 9;

FIG. 11 shows a schematic diagram of the destruction on two typical deoxyribonucleotides in Example 10;

FIG. 12 shows the adsorption and pore size distribution of activated alumina according to one embodiment of the disclosure; and

FIG. 13 shows the proportion of surface hydroxyl content of activated alumina in the total oxygen content of activated alumina according to one embodiment of the disclosure.

### DETAILED DESCRIPTION

To further illustrate the disclosure, embodiments detailing a method for treating refractory organic pollutants in wastewater are described below. It should be noted that the following embodiments are intended to describe and not to limit the disclosure.

The homogeneous Fenton reaction presents many disadvantages in its application, such as being greatly affected by the environmental matrix, having a narrow pH range, and easily generating a large amount of iron sludge. To overcome these shortcomings, a large amount of research and technology have focused on heterogeneous catalysts with variable valence metal bases such as iron/copper/cobalt, utilizing the redox cycle process of metal catalytic sites to activate oxidants. However, the metal valence cycle process inevitably leads to the precipitation of metal ions, secondary pollution of water bodies, and the induced free radicals are greatly affected by coexistent matrices, resulting in low utilization efficiency of oxidants.

During use of Fenton catalysts such as iron oxide, copper oxide, and cobalt oxide, heavy metal ions tend to precipitate, causing secondary pollution to water bodies. In addition, the process of inducing free radicals generally leads to the reaction of free radicals with chloride ions to generate less active chlorine radicals, chlorohydroxyl radicals, etc., which affects the reaction rate.

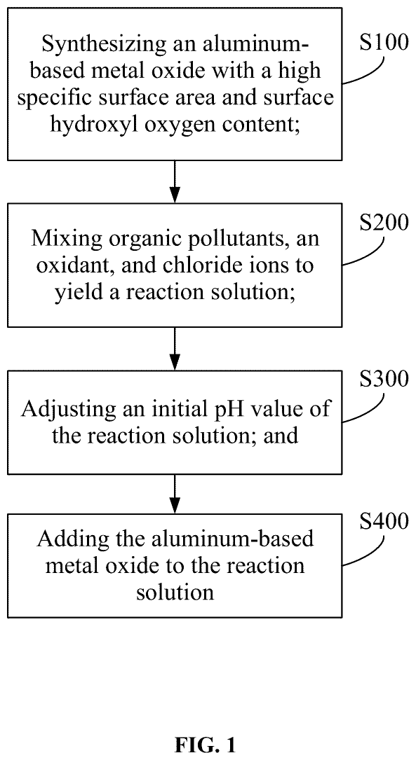

As shown in FIG. 1, a process chart of the method for treating refractory organic pollutants in wastewater of the disclosure comprises: synthesizing an aluminum-based metal oxide with a high specific surface area and surface hydroxyl content; mixing organic pollutants, an oxidant, and chloride ions to yield a reaction solution; adjusting an initial pH value of the reaction solution; and adding the aluminum-based metal oxide to the reaction solution.
S100: synthesizing an aluminum-based metal oxide with a high specific surface area and surface hydroxyl content;
S200: mixing organic pollutants, an oxidant, and chloride ions to yield a reaction solution;
S300: adjusting an initial pH value of the reaction solution; and
S400: adding the aluminum-based metal oxide to the reaction solution Specifically, the aluminum-based metal oxide comprises activated alumina.

In the disclosure, aluminum-based metal oxides, especially activated alumina, have a large specific surface area and porosity. The Al site serves as a strong Lewis acid site and can coordinate with inorganic anions such as fluoride ions and arsenates. However, in the field of advanced oxidation, existing technologies use Al site as a stable carrier, and the active sites are generally controlled by other metal sites. For example, Al₂O₃ is used an inert carrier to load precious metals such as Pd and Pt to activate peroxymonosulfate and degrade organic compounds. There have been no reports on the application of aluminum-based metal oxides directly as Fenton like catalysts to coordinate and complex with oxidants to enhance pollutant degradation.

The preparation of activated alumina comprises coprecipitation method, sol-gel method, gas phase method, etc. Preferably, coprecipitation method is adopted with following operations:
1) Preparation of solutions: dissolve an appropriate amount of aluminum salts (such as aluminum nitrate, aluminum sulfate, etc.) and alkaline precipitants (such as ammonia water, ammonium bicarbonate, etc.) in an appropriate solvent in a certain molar ratio to form two reactant solutions;
2) Mixing the two-reactant solution: slowly add the aluminum salt solution dropwise to the alkaline precipitant solution, and stirring, to fully mixing the two solutions;
3) Precipitation: with the reaction of aluminum salts and alkaline precipitants, precipitants are generated, note that the pH value of the reaction solution is within an appropriate range (8-10); and
4) Calcination treatment: the obtained precipitates are heated to 600-900° C. for 3 hours, washed repeatedly with water 6 times and dried in vacuum to obtain an active aluminum-based oxide.

The specific surface area of the activated alumina ranges from 100 to 300 m²/g; the surface hydroxyl content accounts for 30% to 60% of a total oxygen content of activated alumina.

The addition amount of the activated alumina ranges from 0.50 to 1.50 g/L.

The oxidant is peroxymonosulfate, persulfate, peroxyacetic acid, hydrogen peroxide, or a combination thereof. Peroxymonosulfate can be a commercially available compound salt, such as sodium peroxymonosulfate compound salt and potassium peroxymonosulfate compound salt.

The molar ratio of the organic pollutants to the oxidant in the reaction solution is between 1:10 and 1:1.

The organic pollutants comprise phenols, amino groups, sulfonamides, sulfoxides, or a combination thereof.

The organic pollutants comprise o-methylphenol, carbamazepine, sulfamethoxazole, methylphenyl sulfoxide, or a combination thereof.

A large number of inorganic anions often coexist in wastewater, among which chloride ion is the most common. The oxidation and degradation of new pollutants in chlorine-containing industrial wastewater has always been a challenge in the field of water treatment. This is because the free radicals generated during the Fenton/Fenton-like reaction process will react with chloride ions to generate chlorine free radicals (•Cl, E⁰=2.5 V) with weaker oxidation-reduction ability. This leads to ineffective loss of active free radicals, also produces chlorinated disinfection by-products, seriously endangering the ecological safety of water bodies.

The method utilizes endogenous chloride ions in water bodies to provide potential applications for the deep treatment of organic pollutants in chlorinated wastewater with chloride ion concentrations ranging from 1.0 to 500.0 mM.

### Example 1

Four reaction systems, that is, activated alumina-hydrogen peroxide-chlorine ion, activated alumina-persulfate-chlorine ion, activated alumina-peroxyacetic acid-chlorine ion, and activated alumina-peroxymonosulfate-chlorine ion were prepared respectively. The concentration of carbamazepine in the mixed solution was 10 μM. The dosage of the activated alumina was 1.0 g/L, the concentration of hydrogen peroxide was 10 mM, and the concentration of peroxymonosulfate-persulfate-peroxyacetic acid was 40 μM. The concentration of the chloride ion was 1.0 mM, and the initial pH was 3.0. The mixed solution of each of the four reaction systems was placed in a thermostatic water bath at a temperature of 25° C. with magnetic stirring for 20 min.

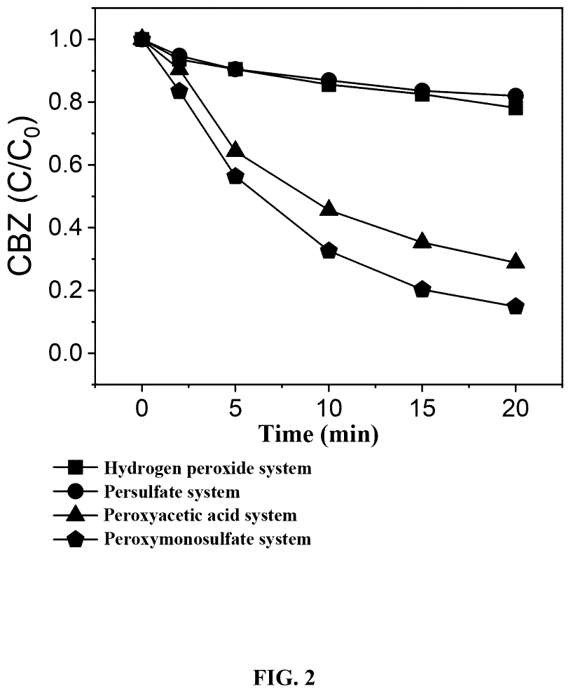

The concentration of carbamazepine was measured at a wavelength of 210 nm using ultra-high performance liquid chromatography. The results are shown in FIG. 2. It can be seen that in the four reaction systems, the removal rates of carbamazepine are 22.9%, 18.1%, 71.2%, and 86.0%, respectively.

The experimental results indicate that the method for treating refractory organic pollutants in wastewater of the disclosure can efficiently remove organic pollutants, among which peroxymonosulfate presents the highest catalytic efficiency. The following examples takes peroxymonosulfate as the object of study.

### Example 2

Four reaction systems, that is, activated alumina-peroxymonosulfate, peroxymonosulfate-chloride ion, activated alumina-chloride ion, and activated alumina-peroxymonosulfate-chloride ion were prepared respectively. The concentration of carbamazepine in the mixed solution was 10 μM. The dosage of activated alumina was 1.0 g/L, and the concentration of peroxymonosulfate was 40 μM. The chloride ion concentration was 1.0 mM, and the initial pH was 3.0. The mixed solution of each of the four reaction systems was placed in a thermostatic water bath at a temperature of 25° C. with magnetic stirring for 20 min.

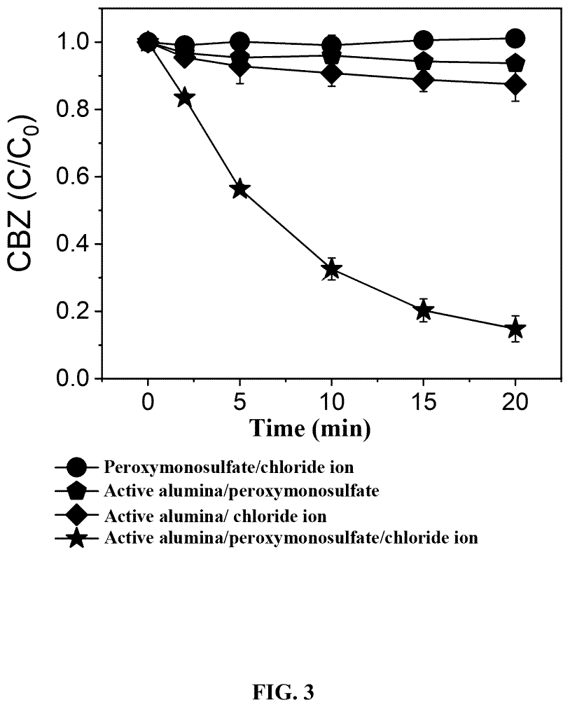

The concentration of carbamazepine was measured at a wavelength of 210 nm using an ultra-high performance liquid chromatograph. The results are shown in FIG. 3. It can be seen that in the four reaction systems, the removal rates of carbamazepine were 1.5%, 6.4%, 12.6%, and 86.0%, respectively. The apparent reaction rates were 0.0002 min-1, 0.0039 min-1, 0.0078 min-1, and 0.10212 min-1, respectively.

The activated alumina alone has poor adsorption capacity for carbamazepine. The oxidation ability of peroxymonosulfate alone is limited. Activated alumina-peroxymonosulfate has poor catalytic ability and cannot catalyze the decomposition of peroxymonosulfate into free radicals. Peroxymonosulfate-chloride ions can react to generate HClO, but the reaction rate is slow, energy barrier is high, with a poor catalytic ability to degrade pollutants.

The experimental results indicate that the method for treating refractory organic pollutants in wastewater of the disclosure can efficiently activate peroxymonosulfate to treat organic pollutants in wastewater.

### Example 3

Two reaction systems, that is, αAl₂O₃-peroxymonosulfate-chloride ion, and γAl₂O₃-peroxymonosulfate-chloride ion were prepared respectively. The concentration of carbamazepine in the mixed solution was 10 μM. The dosage of the activated alumina was 1.0 g/L, and the concentration of peroxymonosulfate was 40 μM. The chloride ion concentration was 1.0 mM, and the initial pH was 3.0. The mixed solution of each of the two reaction systems was placed in a thermostatic water bath at a temperature of 25° C. with magnetic stirring for 20 min.

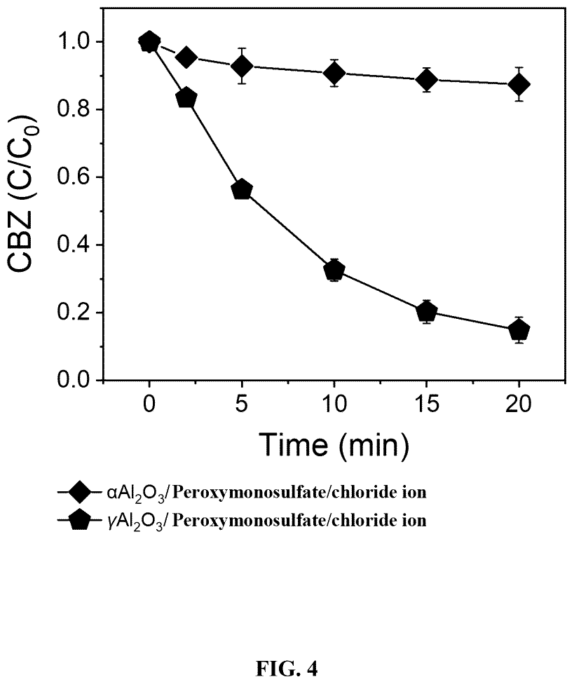

The concentration of carbamazepine was measured at a wavelength of 210 nm using ultra-high performance liquid chromatography. The results are shown in FIG. 4. It can be seen that in the two reaction systems, the removal rates of carbamazepine are 11.2% and 86.0%, respectively.

The experimental results indicate that compared to a crystalline alumina, γ crystalline activated alumina has higher catalytic efficiency.

In this example, αAl₂O₃ was purchased from Shanghai Aladdin Biochemical Technology Co., Ltd., with an average particle size of 209.87 nm.

### Example 4

Six reaction systems, that is, manganese dioxide-peroxymonosulfate-chloride ion, manganese tetroxide-peroxymonosulfate-chloride ion, iron oxide-peroxymonosulfate-chloride ion, cobalt tetroxide-peroxymonosulfate-chloride ion, copper oxide-peroxymonosulfate-chloride ion, and active alumina-peroxymonosulfate-chloride ion were prepared, respectively. The concentration of carbamazepine in the mixed solution was 10 μM. The dosage of activated alumina was 1.0 g/L, and the concentration of peroxymonosulfate was 40 μM. The chloride ion concentration was 1.0 mM, and the initial pH was 3.0. The mixed solution of each of the six reaction systems was placed in a thermostatic water bath at a temperature of 25° C. with magnetic stirring for 20 min.

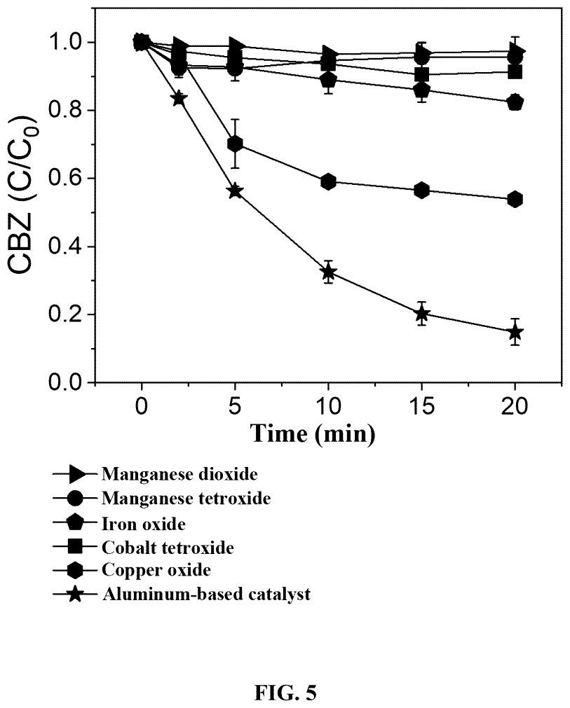

The concentration of carbamazepine was measured at a wavelength of 210 nm using an ultra-high performance liquid chromatograph. The results are shown in FIG. 5. It can be seen that in the four reaction systems, the removal rates of carbamazepine were 2.7%, 4.4%, 17.7%, 8.8%, 46.1% and 86.0%, respectively. The apparent reaction rates were 0.00194 min-1, 0.0036 min-1, 0.01042 min-1, 0.00567 min-1, 0.03718 min-1, 0.10212 min-1, respectively.

The experimental results indicate that compared with traditional Fenton like catalysts, in the presence of chloride ions, activated alumina as a Fenton-like catalyst can significantly enhance the removal of organic pollutants in wastewater.

### Example 5

Six groups of mixed solutions of activated alumina-peroxymonosulfate-chlorine ions were prepared, in which the concentration of carbamazepine was 10 μM, the dosage of activated alumina was 1.0 g/L, the concentration of peroxymonosulfate was 40 μM, and the concentrations of chlorine ions were 0.1 mM, 1.0 mM, 10.0 mM, 100.0 mM, 250.0 mM, and 500.0 mM, respectively. The initial pH was 3.0. The six groups were placed in a thermostatic water bath at 25° C. with magnetic stirring for 20 min.

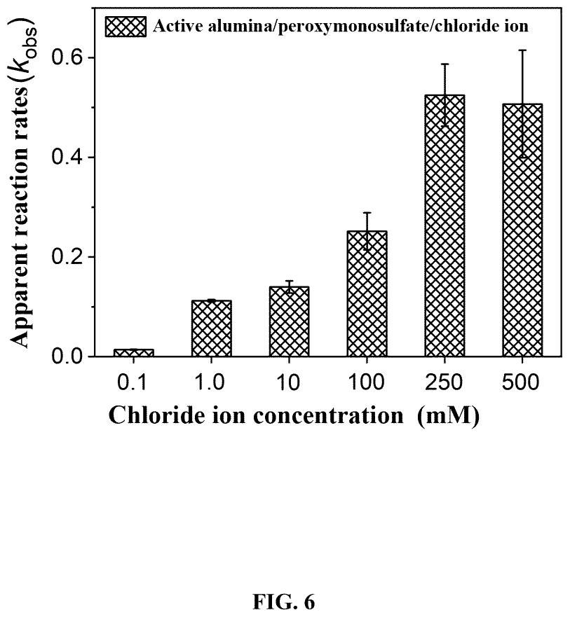

The concentration of carbamazepine was measured at a wavelength of 210 nm using an ultra-high performance liquid chromatograph. The results are shown in FIG. 6. It can be seen that in the six reaction systems, the apparent reaction rates were 0.01407 min-1, 0.11214 min-1, 0.13987 min-1, 0.25144 min-1, 0.52488 min-1, and 0.50697 min-1, respectively.

The experimental results indicate that the method for treating refractory organic pollutants in wastewater can utilize endogenous chloride ions in the water body for the deep treatment of chlorine-containing wastewater with a chloride ion concentration in the range of 1.0-500.0 mM.

### Example 6

Three groups of mixed solutions of activated aluminum oxide-peroxymonosulfate-chlorine ion were prepared, in which the concentration of carbamazepine was 10 μM, the dosage of activated alumina was 1.0 g/L, the concentration of peroxymonosulfate was 40 μM, and the concentrations of chlorine ions was 1.0 mM. The initial pH was 3.0, 5.0, and 7.0 respectively. The three groups were placed in a thermostatic water bath at 25° C. with magnetic stirring for 20 min.

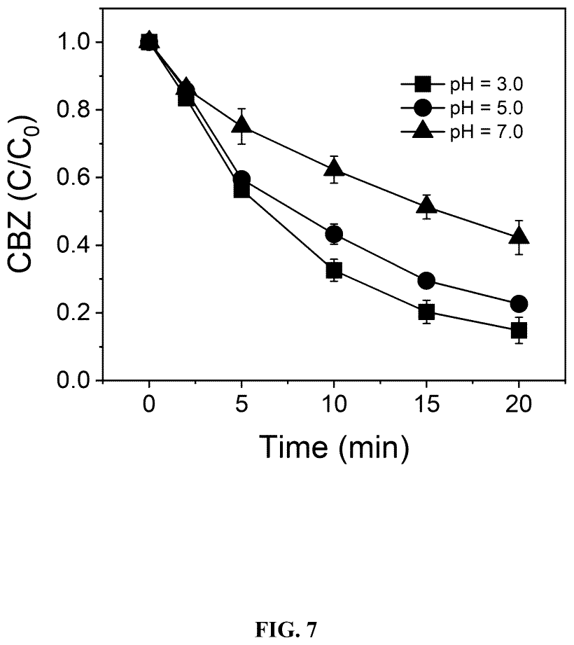

The concentration of carbamazepine was measured at a wavelength of 210 nm using an ultra-high performance liquid chromatograph. The results are shown in FIG. 7. It can be seen that in the three reaction systems, the removal rates of carbamazepine were 86.0%, 77.4% and 57.8%, respectively.

The experimental results indicate that the method for treating refractory organic pollutants in wastewater is capable of realizing efficient removal of target pollutants under acidic/neutral conditions.

### Example 7

Three groups of mixed solutions of activated aluminum oxide-peroxymonosulfate-chlorine ion were prepared, in which the concentration of carbamazepine was 10 μM, the dosage of activated alumina was 1.0 g/L, and the concentrations of chlorine ions was 1.0 mM. The initial pH was 3.0. The molar ratios of carbamazepine to peroxymonosulfate in the three mixed solutions were 1:1, 1:4 and 1:10, respectively. Each of the three groups of mixed solutions was placed in a thermostatic water bath at a temperature of 25° C. with magnetic stirring for 20 min.

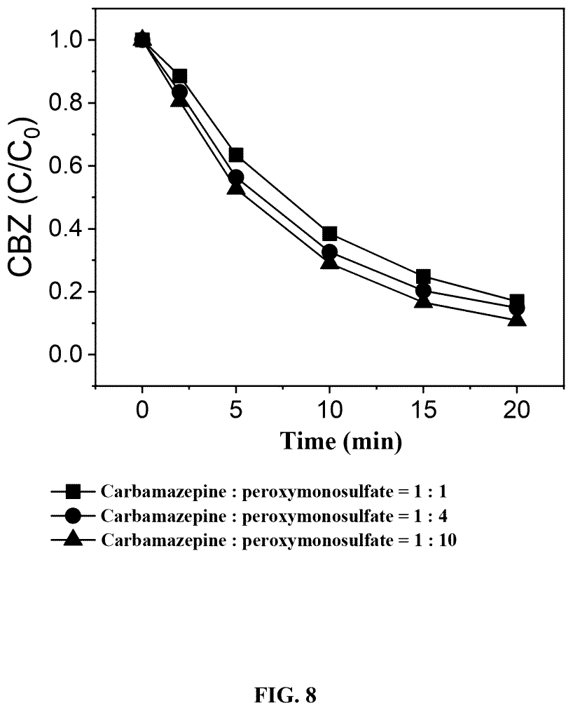

The concentration of carbamazepine was measured at a wavelength of 210 nm using an ultra-high performance liquid chromatograph. The results are shown in FIG. 8. It can be seen that in the four reaction systems, the removal rates of carbamazepine were 83.2%, 86.0% and 90.0%, respectively.

The experimental results indicate that the target pollutants can be efficiently removed when the molar ratio of carbamazepine to peroxymonosulfate was 1:10 to 1:1.

### Example 8

Four groups of mixed solutions of activated aluminum oxide-peroxymonosulfate-chlorine ion were prepared, in which the concentration of organic matter in the four mixed solutions was 10 μM. The dosage of activated alumina was 1.0 g/L, and the concentration of peroxymonosulfate was 40 μM. The chloride ion concentration was 1.0 mM and the initial pH was 3.0. The organic matter comprised O-methylphenol, a representative pollutant of phenols, carbamazepine, a representative pollutant of amino groups, sulfamethoxazole, a representative pollutant of sulfonamides, and methylphenyl sulfoxide, a representative pollutant of sulfoxides. Each of the four groups of mixed solutions was placed in a thermostatic water bath at a temperature of 25° C. with magnetic stirring for 20 min.

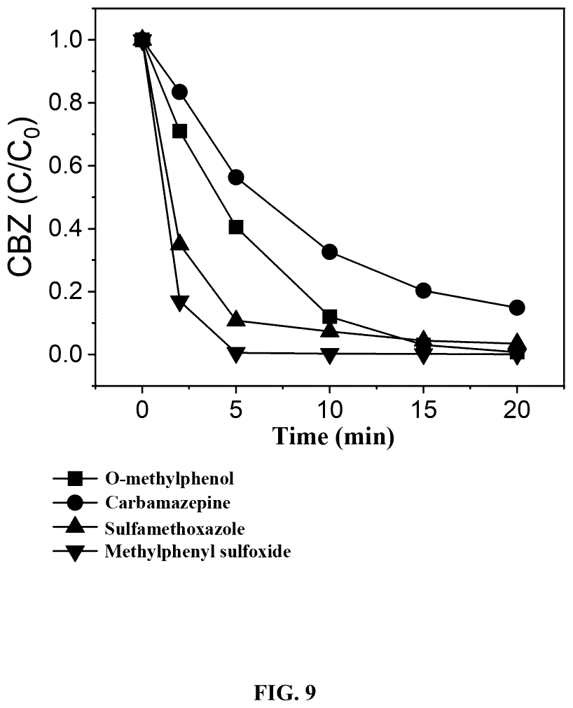

The concentration of pollutants was measured using an ultra-high performance liquid chromatograph, and the results are shown in FIG. 9. In the four mixed solutions, the removal rates of organic matter were 100%, 86.0%, 97.7%, and 100.0%, respectively.

The results indicate that the method for treating recalcitrant organic pollutants in wastewater achieves efficient degradation of phenolic, amino, sulfonamide, and sulfoxide pollutants within 20 minutes, indicating that the method has universality and great potential for application in the organic treatment of chlorine containing wastewater.

### Example 9

Six groups of mixed solutions of activated aluminum oxide-peroxymonosulfate-chlorine ion were prepared. The concentration of carbamazepine in the six mixed solutions was 10 μM. The concentration of peroxymonosulfate was 40 μM. The chloride ion concentration was 1.0 mM, the initial pH was 3.0, and the dosage of activated alumina was 0.25 g/L, 0.50 g/L, 0.75 g/L, 1.0 g/L, 1.25 g/L, and 1.50 g/L, respectively. Each of the six groups of mixed solutions was placed in a thermostatic water bath at a temperature of 25° C. with magnetic stirring for 20 min.

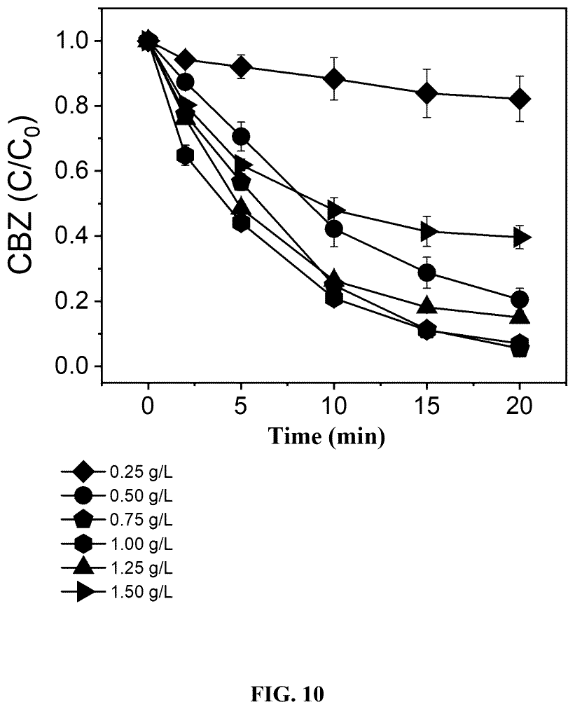

The concentration of carbamazepine was measured at a wavelength of 210 nm using an ultra-high performance liquid chromatograph, and the degradation reaction rate of carbamazepine was fitted in the six mixed solutions. The results are shown in FIG. 10. In the 6 mixed solutions, the removal rates of carbamazepine were 17.9%, 79.5%, 94.5%, 93.1%, 84.9%, and 60.4%, respectively.

The experimental results indicate that when the addition amount of active alumina is in the range of 0.5 g/L to 1.5 g/L, carbamazepine can be efficiently removed.

### Example 10

Two groups of mixed solutions of activated aluminum oxide-peroxymonosulfate-chlorine ion were prepared, in which the concentration of peroxymonosulfate was 40 μM. The chloride ion concentration was 10.0 mM. The initial pH was 3.0. The dosage of the activated alumina was 1.0 g/L, and the representative deoxyribonucleotides are 2′-deoxyguanosine, and 2′, 3′-dideoxythymidine. The initial concentration was 2.0 μM. Each of the two groups of mixed solutions was placed in a thermostatic water bath at a temperature of 25° C. with magnetic stirring for 20 min.

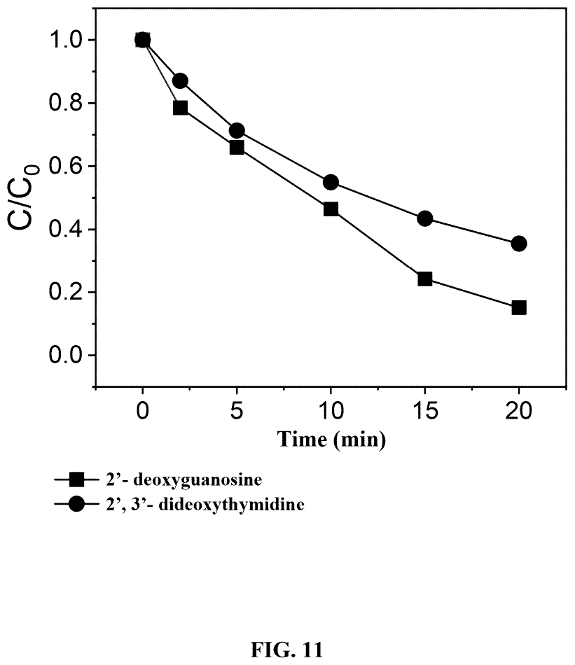

The concentration of deoxyribonucleotides was measured using an ultra-high performance liquid chromatograph, and the degradation rate of carbamazepine in the two mixed solutions was fitted. The results are shown in FIG. 11. In the two mixed solutions, the removal rates of 2′-deoxyguanosine and 2′, 3′-dideoxythymidine were 85.5% and 64.5%, respectively.

The experimental results indicate that the method has great potential for bacterial disinfection in wastewater, and has potential application prospects in water purification of chlorinated water systems.

The activated alumina in Examples 1 to 10 refers to γ aluminum oxide. The specific surface area of the activated alumina ranges from 100 m²/g to 300 m²/g. The surface hydroxyl content accounts for 30% to 60% of the total oxygen content of the activated alumina.

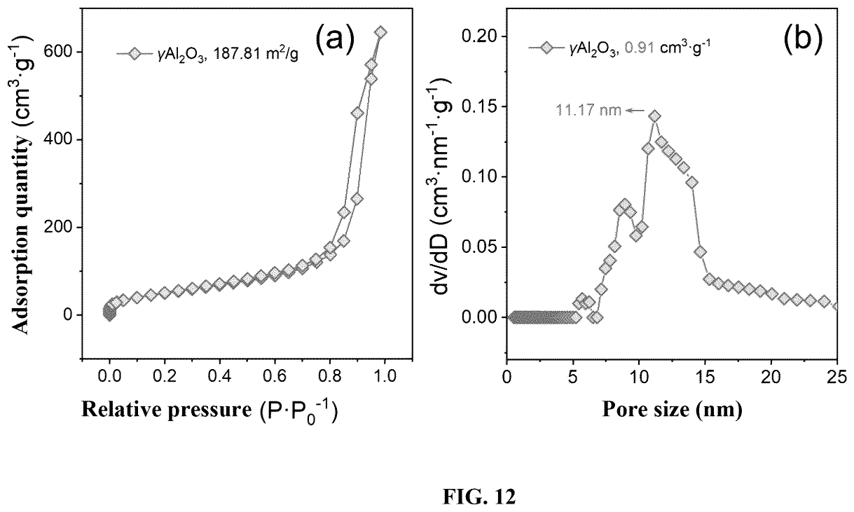

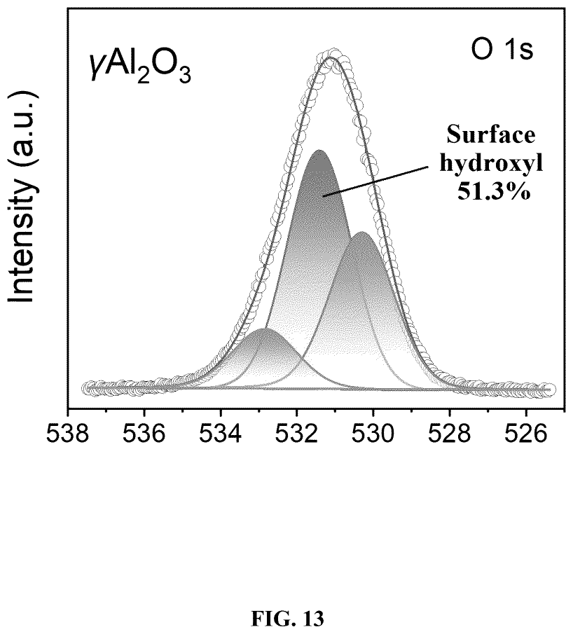

In Examples 1 to 10, the specific surface area of the activated alumina is 187.81 m²/g, and the pore volume is 0.91 cm³/g, as shown in FIG. 12. As shown in FIG. 13, the surface hydroxyl content accounts for 51.3% of the total oxygen content of activated alumina.

The peroxymonosulfate used in the disclosure is a commercially available potassium peroxymonosulfate complex salt (≥42% KHSO₅ basis); persulfate is a commercially available potassium persulfate (K₂S₂O₈, 99.5%).

Unless otherwise stated, all technical as well as scientific terms used herein have the same meaning as commonly understood by one of ordinary skill in the art to which the disclosure belongs. When the mass, concentration, temperature, time, or other value or parameter is expressed as a range, a preferred range, or a series of ranges bounded by an upper preferred value and a lower preferred value, this should be construed as a specific disclosure of all ranges formed by a pair of an upper or preferred value of a range with a lower or preferred value of a range, whether or not the range is separately disclosed. For example, the range of 1-50 should be understood to include a range selected from 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, any number, combination of numbers, or subrange of numbers, and all fractional values between the above integers, e.g., 1.1, 1.2, 1.3, 1.4, 1.5, 1.6, 1.7, 1.8, and 1.9. With respect to subranges, preferably referring to the range that extends from any endpoint in the range of “nested subranges.” For example, nested subranges of exemplary ranges 1-50 may include 1-10, 1-20, 1-30, and 1-40 in one direction, or 50-40, 50-30, 50-20, and 50-10 in another direction.

It will be obvious to those skilled in the art that changes and modifications may be made, and therefore, the aim in the appended claims is to cover all such changes and modifications.

What is claimed is:

1. A method for treating refractory organic pollutants in wastewater, the method comprising:
1) synthesizing an aluminum-based metal oxide with a high specific surface area and surface hydroxyl content;
2) mixing organic pollutants, an oxidant, and chloride ions to yield a reaction solution;
3) adjusting an initial pH value of the reaction solution; and
4) adding the aluminum-based metal oxide to the reaction solution.

2. The method of claim 1, wherein the aluminum-based metal oxide comprises activated alumina.

3. The method of claim 2, wherein a specific surface area of the activated alumina ranges from 100 to 300 m²/g; the surface hydroxyl content accounts for 30% to 60% of a total oxygen content of activated alumina.

4. The method of claim 3, wherein an addition amount of the activated alumina ranges from 0.50 to 1.50 g/L.

5. The method of claim 1, wherein the initial pH value of the reaction solution is between 3.0 and 7.0.

6. The method of claim 1, wherein the oxidant is peroxymonosulfate, persulfate, peroxyacetic acid, hydrogen peroxide, or a combination thereof.

7. The method of claim 1, wherein a molar ratio of the organic pollutants to the oxidant in the reaction solution is between 1:10 and 1:1.

8. The method of claim 1, wherein the chloride ions have a concentration great than or equal to 1.0 mmol/L.

9. The method of claim 1, wherein the organic pollutants comprise phenols, amino groups, sulfonamides, sulfoxides, or a combination thereof.

10. The method of claim 9, wherein the organic pollutants comprise o-methylphenol, carbamazepine, sulfamethoxazole, methylphenyl sulfoxide, or a combination thereof.
